(19) United States
(12) Patent Application Publication
(10) Pub. No.: US 2026/0308377 A1
(43) Pub. Date: Oct. 8, 2026

(54) SELF-CURABLE SILICONE RESINS FOR NON-STICK SURFACES

(71) Applicant: PPG Industries Ohio, Inc., Cleveland, OH (US)

(72) Inventors: Mukesh Kumar, Wexford, PA (US); Gianluca Cattinari, Fanano (IT); Ian Michael Jones, Pittsburgh, PA (US); Matteo Sperindio, Brescia (IT); John Robert Yetter, Jr., Allison Park, PA (US); Manish Kr Mishra, Pittsburgh, PA (US)

(73) Assignee: PPG Industries Ohio, Inc., Cleveland, OH (US)

(21) Appl. No.: 19/481,567

(22) PCT Filed: May 7, 2024
(86) PCT No.: PCT/US2024/028122

§ 371 Date: Nov. 5, 2025

Related U.S. Application Data
(60) Provisional application No. 63/501,044, filed on May 9, 2023.
(60) Provisional application No. 63/516,628, filed on Jul. 31, 2023.

(51) Int. Cl. C08L 83/04; B05D 3/02; B05D 5/08; C08G 77/00; C09D 5/02; C09D 183/04

(52) U.S. Cl. CPC C08L 83/04; B05D 3/0272; B05D 5/08; C08G 77/70; C08G 77/80; C09D 5/022; C09D 183/04; B05D 2202/25; B05D 2401/21; B05D 2518/12

(57) ABSTRACT

A polysiloxane resin coating composition that may be applied to the surface of a substrate to form a crack and heat resistant coating. The coating composition may comprise a polysiloxane resin, a surfactant, and a solvent. The polysiloxane resin may be formed from siloxane monomer units. The polysiloxane resin may comprise less than 80 mol % of T siloxane monomer units, and less than 1 mol % of M and Q siloxane monomer units, based on the total moles of siloxane monomer units in the polysiloxane resin. A ratio of the surfactant to the polysiloxane resin may be from 0.01 to 0.09.

### CROSS-REFERENCE TO RELATED APPLICATIONS

This application claims the benefit under 35 U.S.C. § 119(e) of U.S. Provisional Application No. 63/501,044 entitled “SELF-CURABLE SILICONE RESINS FOR BAKEWARE”, filed on May 9, 2023, and U.S. Provisional Application No. 63/516,628 entitled “SELF-CURABLE SILICONE RESINS FOR NON-STICK SURFACES”, filed on Jul. 31, 2023, both of which are incorporated by reference in their entireties.

### FIELD

The present disclosure relates to a polysiloxane resin coating composition, a method of making the coating composition, and an article coated with the coating composition.

### BACKGROUND

Heat resistant coatings are applied to substrates such as cookware, bakeware or other cooking appliances to provide functions such as aiding in heat transfer, providing a non-stick release surface, and/or providing a decorative color or aesthetic finish. Prior coating compositions may contain fluoropolymers as binders or release agents, which could potentially contain per/polyfluoroalkyl substances (PFAS). The regulatory landscape has become increasingly concerned about PFAS, including fluoropolymers.

### SUMMARY

The present disclosure provides a curable coating composition including a polysiloxane resin formed from siloxane monomers and a solvent. The siloxane monomers include [R¹Si(O)_{3/2}]ₓ; [R²R³Si(O)]_{y}; and [R⁴Si(O)_{3/2}]_{z}; wherein: x is any integer from 1 to 50; y is any integer from 1 to 20; z is any integer from 1 to 50; R¹ is a C₁-C₃₀ linear or C₃-C₃₀ cyclic alkyl group; R² and R³ are each independently a C₁-C₃₀ linear or C₃-C₃₀ cyclic alkyl group, or a C₆ or C₇ aryl group; R⁴ is a C₆ or C₇ aryl group. The composition comprises less than 5 wt. % of any fluorine-containing component, based on a total weight of the composition. The present disclosure further provides an article coated with the coating composition previously described.

The present disclosure provides a method of coating a substrate including applying, to a substrate, a coating composition and curing the coating composition. The coating composition includes a polysiloxane resin formed from siloxane monomers and a solvent. The siloxane monomers include [R¹Si(O)_{3/2}]ₓ; [R²R³Si(O)]_{y}; and [R⁴Si(O)_{3/2}]_{z}; wherein: x is any integer from 1 to 50; y is any integer from 1 to 20; z is any integer from 1 to 50; R¹ is a C₁-C₃₀ linear or C₃-C₃₀ cyclic alkyl group; R² and R³ are each independently a C₁-C₃₀ linear or C₃-C₃₀ cyclic alkyl group, or a C₆ or C₇ aryl group; R⁴ is a C₆ or C₇ aryl group. The composition comprises less than 5 wt. % of any fluorine-containing component, based on a total weight of the composition.

The present disclosure provides a curable composition including a polysiloxane resin formed from siloxane monomer units; a solvent and a surfactant. The polysiloxane resin includes less than 80 mol % of T siloxane monomer units, based on the total moles of siloxane monomer units in the polysiloxane resin. The polysiloxane resin includes less than 1 mol % of M and Q siloxane monomer units, based on the total moles of siloxane monomer units in the polysiloxane resin. The surfactant includes at least one of a surfactant of Formula IIA

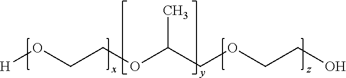

wherein x is an ethylene glycol monomer, y is a propylene glycol monomer and z is an ethylene glycol monomer;
a surfactant of Formula IIB

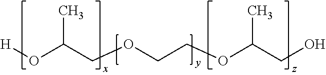

wherein x is a propylene glycol monomer, y is an ethylene glycol monomer, and z is propylene glycol monomer;
a surfactant of Formula III

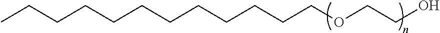

wherein n=16-20; and
a combination of surfactants of Formula IIA, IIB, and III. A weight ratio of the surfactant to the polysiloxane resin is from 0.01 to 0.09 based on the total weight of the composition. The composition includes less than 1 wt. % of any fluorine-containing component, based on a total weight of the composition. The present disclosure further provides an article coated with the aforementioned curable coating composition.

The present disclosure provides a method of coating a substrate including applying, to a substrate, a coating composition and curing the coating composition. The coating composition includes a polysiloxane resin formed from siloxane monomer units and having the following formula: RₙSiO((4-n)/2), wherein R is alkyl or aryl; a solvent; and a surfactant. The polysiloxane resin includes less than 80 mol % of T siloxane monomer units, based on the total moles of siloxane monomer units in the polysiloxane resin. The polysiloxane resin includes less than 1 mol % of M and Q siloxane monomer units, based on the total moles of siloxane monomer units in the polysiloxane resin. The surfactant includes at least one of: a surfactant of Formula IIA

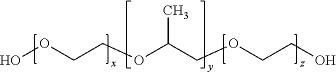

wherein x is an ethylene glycol monomer, y is a propylene glycol monomer and z is an ethylene glycol monomer;
a surfactant of Formula IIB

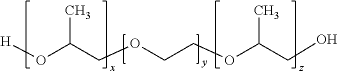

wherein x is a propylene glycol monomer, y is an ethylene glycol monomer, and z is propylene glycol monomer;
a surfactant of Formula III

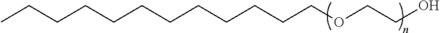

wherein n=16-20; and
a combination of surfactants of Formula IIA, IIB, and III. A weight ratio of the surfactant to the polysiloxane resin is from 0.01 to 0.09, based on the total weight of the coating composition.

The present disclosure provides a polysiloxane resin formed from siloxane monomer units: [R¹Si(O)_{3/2}]x; [R²R³Si(O)]_{y}; [R⁴Si(O)_{3/2}]_{z} wherein: x is any integer from 1 to 50; y is any integer from 1 to 20; z is any integer from 1 to 50; R¹ is a C₁-C₃₀ linear or C₃-C₃₀ cyclic alkyl group; R² and R³ are each independently a C₁-C₃₀ linear or C₃-C₃₀ cyclic alkyl group, or a C₆ or C₇ aryl group; and R⁴ is a C₆ or C₇ aryl group. The polysiloxane resin comprises less than 80 mol % of T siloxane monomer units, based on the total moles of siloxane monomer units in the polysiloxane resin. The polysiloxane resin comprises less than 1 mol % of M and Q siloxane monomer units, based on the total moles of siloxane monomer units in the polysiloxane resin.

### DETAILED DESCRIPTION

The present disclosure provides a polysiloxane resin coating composition, comprising a polysiloxane resin, a solvent, and additives.

### I. Definitions

For purposes of the following detailed description, it is to be understood that the disclosure may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” For example, numerical ranges provided for weight percentages of components or amounts of components added should be construed as being modified by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges from (and including) the recited minimum value of 1 to the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

“Wet” coating composition as used herein refers to an uncured coating composition.

“Dry” coating composition as used herein refers to a cured coating composition.

“Substrate” and “article” as used herein refers to an object or other item with a surface onto which a coating composition may be applied.

“Solids” refers to the non-volatile components present in a composition of volatile and non-volatile components. As used herein, a weight percentage based on “solids” refers to an amount of a component based on a total weight of the polysiloxane resin.

“Resin solids” refers to the solid components that make up the binder or film-forming components of the composition. As used herein, a weight percentage based on “resin solids” refers to an amount of a component based on a total weight of the binder or film-forming components of a composition.

“Siloxane monomer” refers to a monomer including a silicon atom with one or more Si—O—R linkages (wherein R is an organic group) that is capable of reacting with other such monomers via hydrolysis and condensation to form polysiloxane resins with Si—O—Si linkages.

“Emulsion” refers to a fine dispersion of one liquid within another liquid. As used herein, a “polysiloxane resin coating emulsion” refers to an emulsion comprising polysiloxane resin coating composition dispersed into a solvent. As used herein, an “emulsion solution” refers to a diluted emulsion comprising polysiloxane resin coating composition dispersed into a solvent.

### II. Solvent Borne Polysiloxane Resin Coating Composition

The present disclosure provides a polysiloxane resin coating composition that may comprise polysiloxane resin, a solvent, and additives.

### A. Polysiloxane Resin

The polysiloxane resin may be prepared via hydrolysis and condensation of at least two different types of siloxane monomers, water, solvent, and a catalyst.

The polysiloxane resins may comprise a weight average molecular weight from 1000 g/mol, 1200 g/mol, 1500 g/mol, 1800 g/mol, 2000 g/mol to 4000 g/mol, 6000 g/mol, 8000 g/mol, 10000 g/mol, 20000 g/mol, or any range including any two of the foregoing values as end points, such as 1000 to 20000 g/mol, 1200 to 10000 g/mol, 1500 to 8000 g/mol, 1800 to 6000 g/mol, or 2000 to 4000 g/mol, as determined by gel permeation chromatography using polystyrene polymer beads for calibration standards.

The polysiloxane resin may include aryl and alkyl groups, such as phenyl and methyl respectively. The polysiloxane resin may comprise a molar ratio of aryl groups to silicon greater than 0.75, greater than 0.80, greater than 0.85, or greater than 0.90, wherein the molar ratio is based on total moles of aryl groups divided by total moles of silicon atoms based on mol % of monomers from which the polysiloxane resin is formed.

The polysiloxane resin may comprise a molar ratio of aryl groups to silicon greater than 0.90, greater than 0.95, greater than 1.00, greater than 1.10, greater than 1.40, or greater than 1.50, wherein the molar ratio is based on total moles of aryl groups divided by total moles of silicon atoms based on mol % of monomers from which the polysiloxane resin is formed.

The polysiloxane resin may comprise a molar ratio of alkyl to aryl groups of less than 0.6, less than 0.5, less than 0.4, or less than 0.3, wherein the molar ratio is based on total moles of alkyl groups divided by total moles of aryl atoms based on mol % of monomers from which the polysiloxane resin is formed.

The polysiloxane resin coating composition may comprise a weight percentage of polysiloxane resin from 50 wt. %, 60 wt. %, 70 wt. % to 75 wt. %, 80 wt. %, 90 wt. %, or any range including any two of the foregoing values as endpoints, such as 50 wt. % to 90 wt. %, 60 wt. % to 80 wt. %, or 70 wt. % to 75 wt. %, wherein the weight percent is based on the total weight of the “wet” coating composition.

The polysiloxane resin coating composition may comprise a weight percentage of polysiloxane resin from 40 wt. %, 50 wt. %, 60 wt. % to 70 wt. %, 80 wt. %, 90 wt. %, or any range including any two of the foregoing values as endpoints, such as 40 wt. % to 90 wt. %, 50 wt. % to 80 wt. %, or 60 wt. % to 70 wt. %, wherein the weight percent is based on the total weight of the “dry” coating composition.

i. Siloxane Monomers

The polysiloxane resin may be formed as the reaction product of multiple siloxane monomers, such as three siloxane monomer units.

The polysiloxane resin may comprise a weight percentage of siloxane monomers from 65 wt. %, 70 wt. %, 75 wt. % to 80 wt. %, 90 wt. %, 95 wt. %, or any range including any two of the foregoing values as endpoints, such as 65 wt. % to 95 wt. %, 70 wt. % to 90 wt. %, or 75 wt. % to 80 wt. %, wherein the weight percent is based on the total solids weight of the polysiloxane resin.

The siloxane monomers may be described according to the degree of oxygen substitution, or functionality, on the central silicon.

TABLE 1
Siloxane Monomer Types

| Structural formula | Functionality | Symbol |
|---|---|---|
| R₃Si—O— | Monofunctional | M |
| 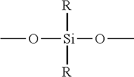 | Difunctional | D |
| 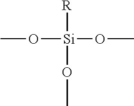 | Trifunctional | T |
| 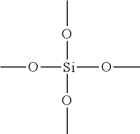 | Tetrafunctional | Q |

“Linear” organopolysiloxanes typically contain mostly D siloxane monomer units, which results in polydiorganosiloxanes that are fluids of varying viscosity, depending on the “degree of polymerization” or DP as indicated by the number of D units in the polydiorganosiloxane. When T siloxy units are predominately used to prepare an organopolysiloxane, the resulting organosiloxane is often referred to as a “silsesquioxane resin”. When M and Q siloxy units are predominately used to prepare an organopolysiloxane, the resulting organosiloxane is often referred to as a “MQ resin”. MQ resins are non-linear resins and are more cage-like with high degrees of crosslinking.

The polysiloxane resin of the present disclosure may be linear and include D and T siloxane monomer units.

Suitable trifunctional siloxane monomers used to produce the polysiloxane resin may include methyltrimethoxy silane, methyltriethoxy silane, phenyltrimethoxy silane, phenyltriethoxy silane, ethyltrimethoxy silane, propyltrimethoxy silane, ethyltriethoxy silane, octyltriethoxy silane, and propyltriethoxy silane.

Suitable difunctional siloxane monomers used to produce the polysiloxane resin may include dimethyldimethoxy silane, diphenyldimethoxy silane, diphenyldiethoxy silane, methylphenyldimethoxy silane, dimethyldiethoxy silane, diphenyldiethoxy silane, and methylphenyldiethoxy silane.

During the synthesis of the polysiloxane resin, Si—OR may be converted to Si—OH or Si—O—Si such that 50 wt. %, 55 wt. % 60 wt. % to 65 wt. %, 70 wt. % 75 wt. %, or any range including any two of the foregoing values as endpoints, such as 50 wt. % to 75 wt. %, 55 wt. % to 70 wt. %, or 60 wt. % to 65 wt. %, of the Si—OR within the siloxane monomers may be converted to Si—OH or Si—O—Si.

The polysiloxane resins may comprise a weight percentage of residual Si—OR, Si—OH, or a combination of Si—OH and Si—OR groups from 5 wt. %, 6 wt. %, 8 wt. % to 10 wt. %, 12 wt. %, 15 wt. %, or any range including any two of the foregoing values as end points, such as 5 wt. % to 15 wt. %, 6 wt. % to 12 wt. %, or 8 wt. % to 10 wt. %, wherein the weight percent is based on the total solids weight of the polysiloxane resin.

The polysiloxane resin may comprise:

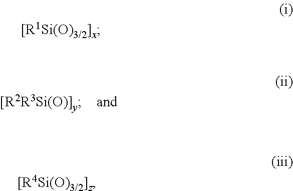

wherein:
   x is any integer from 1 to 50 (inclusive of all integers such as 1, 2, 3, 4, 5, . . . up to 50, or any range including any two of the foregoing as endpoints);
   y is any integer from 1 to 20 (inclusive of all integers such as 1, 2, 3, 4, 5, . . . up to 20, or any range including any two of the foregoing as endpoints);
   z is any integer from 1 to 50 (inclusive of all integers such as 1, 2, 3, 4, 5, . . . up to 50, or any range including any two of the foregoing as endpoints);
[R¹Si(O)3/2]x is a T unit, and R¹ is a C1-C30 (inclusive of all integers such as 1, 2, 3, 4, 5, . . . up to 30, or any range including any two of the foregoing as endpoints) linear or cyclic alkyl group;
[R²R³Si(O)]y is a D unit, and R² and R³ are each independently a C1-C30 (inclusive of all integers such as 1, 2, 3, 4, 5, . . . up to 30, or any range including any two of the foregoing as endpoints) linear or cyclic alkyl group, or a C6 or C7 aryl group; and
[R⁴Si(O)3/2]z is a T unit, and R⁴ is a C6 or C7 aryl group.

The polysiloxane resin may comprise an amount of [R¹Si(O)3/2]x from 5 mol %, 10 mol %, 15 mol %, to 25 mol %, 30 mol %, 40 mol %, or any range including any two of the foregoing values as endpoints, such as 5 mol % to 40 mol %, 10 mol % to 30 mol %, or 15 mol % to 25 mol %, wherein the mole percent is based on total molar mass of the polysiloxane resin.

The polysiloxane resin may comprise an amount of [R²R³Si(O)]y from 5 mol %, 6 mol %, 7 mol %, to 8 mol %, 9 mol %, 10 mol %, or any range including any two of the foregoing values as endpoints, such as 5 mol % to 10 mol %, 6 mol % to 9 mol %, or 7 mol % to 8 mol %, wherein the mole percent is based on total molar mass of the polysiloxane resin.

The polysiloxane resin may comprise an amount of [R⁴Si(O)3/2]z from 40 mol %, 50 mol %, 60 mol %, to 70 mol %, 75 mol %, 80 mol %, or any range including any two of the foregoing values as endpoints, such as 40 mol % to 80 mol %, 50 mol % to 75 mol %, or 60 mol % to 70 mol %, wherein the mole percent is based on total molar mass of the polysiloxane resin.

The polysiloxane resin may, preferably, comprise a total amount of T siloxane monomer units in an amount of less than 80 mol %, less than 70 mol %, less than 65 mol %, less than 60 mol %, less than 55 mol %, or less than 50 mol %, based on the total moles of the siloxane monomer units in the polysiloxane resin.

The polysiloxane resin may comprise a total amount of D siloxane monomer units in an amount greater than 20 mol %, greater than 30 mol %, greater than 35 mol %, greater than 40 mol %, greater than 45 mol %, or greater than 50 mol %, based on the total moles of the siloxane monomer units in the polysiloxane resin.

Suitable commercially available polysiloxane resins may include the resins summarized in Table 2, below.

TABLE 2
Structural Properties of Commercial Polysiloxane resins

| | | Si—OH | | Molecular |
|---|---|---|---|---|
| Commercial | Me-to-Ph | content | Degree of | weight |
| resin | Ratio | (%) | substitution | (1000) |
| Dowsil RSN-0233¹ | 0.77 | 5 | 1.15 | 2.0-4.0 |
| Dowsil RSN-0431² | 0.83 | 3 | 1.4 | 2.0-7.0 |
| Dowsil RSN-0220¹ | 0.5 | 6 | 1.2 | 2.0-4.0 |
| Silres 604¹ | 1 | 3.5-7.0 | — | 2.4-3.1 |

¹Polysiloxane resin in flake form.
²Polysiloxane resin in solvent

The polysiloxane resin may be essentially free, substantially free, or completely free of M and Q siloxane monomer units. By essentially free of M and Q units, it is meant that the polysiloxane resin may comprise less than 5 mol % of M and Q units, based on the total moles of siloxane units in the polysiloxane resin. By substantially free of M and Q units, it is meant that the polysiloxane resin may comprise less than 1 mol % of M and Q units, based on the total moles of siloxane units in the polysiloxane resin. By completely free of M and Q units, it is meant that the polysiloxane resin may comprise less than 0.1 mol % of M and Q units, based on the total moles of the siloxane units in the polysiloxane resin.

The polysiloxane resin with less than 80 mol % of T siloxane monomer units/greater than 20 mol % of D units of the present disclosure may have more flexibility than a coating composition comprising an MQ polysiloxane resin. Overly crosslinked MQ resins and silsesquioxane resins with greater than 80 mole % of T units may lack flexibility that is important to match the thermal expansion of metal substrates. Coating compositions that lack flexibility may have decreased thermal resistance and crack when exposed to heat.

ii. Solvent

The polysiloxane resin may comprise a solvent, such as an organic solvent, in an amount from 5 wt. %, 10 wt. %, 15 wt. % to 20 wt. %, 25 wt. %, to 35 wt. %, or any range using any of the foregoing values as endpoints, such as 5 wt. % to 35 wt. %, 10 wt. % to 25 wt. %, or 15 wt. % to 20 wt. %, based on the total weight of the polysiloxane resin.

Inclusion of a solvent in the polysiloxane resin may create a resin solution that allows for successful emulsification of low fluorine-containing component coatings with a low weight ratio of surfactant, discussed further below, to polysiloxane resin. In polysiloxane coating compositions that comprise a surfactant, the weight ratio of surfactant to polysiloxane resin may be from 0.01, 0.02, 0.03 to 0.05, 0.07, to 0.09, or any range using any of the foregoing values as endpoints, such as 0.01 to 0.09, 0.02 to 0.07, or 0.03 to 0.05, based on the total weight of the coating composition.

Increasing the amount of solvent beyond the above ranges can inhibit emulsion formation. Additionally using too little solvent can also prevent emulsification. Compositions with too little solvent may require an excess of surfactant. High surfactant loadings are not preferred as they may yellow at high temperatures and leach from the coating.

### B. Condensation Catalyst

The polysiloxane resin coating composition may comprise a condensation catalyst. The condensation catalyst may be an acid catalyst or a base catalyst.

Suitable acid catalysts may include organic acids such as, p-toluenesulfonic acid, n-butylphosphoric acid, and the like, or a metallic salt such as, tin naphthenate, tin benzoate, tin octoate, tin butyrate, tin-2-ethylhexanoate, dibutyltin dioctoate, dibutyltin dilaurate, dibutyltin diacetate, iron stearate, lead octoate, and the like.

Suitable base catalysts may include ammonia solution in water, ammonium hydroxide, tetra alkylammonium hydroxide, alkali metal hydroxides (e.g. NaOH, KOH), alkaline metal oxide (e.g. CaO, MgO), organic amines (e.g. R₃N, R₂NH, RNH₂), alcoholamines (e.g. ethanolamine), or aminosilane (e.g. NH₂(CH₂)₃Si(OR)₃, NH₂(CH₂)₂NH(CH₂)₃Si(OR)₃).

The polysiloxane resin coating composition may comprise a weight percentage of any of the above catalysts from 0.01 wt. %, 0.02 wt. %, 0.05 wt. %, 0.10 wt. % to 1 wt. %, 2 wt. %, 5 wt. %, 10 wt. %, or any range including any two of the foregoing values as endpoints, such as 0.01 wt. % to 10 wt. %, 0.02 wt. % to 5 wt. %, 0.05 wt. % to 2 wt. %, or 0.10 wt. % to 1 wt. %, wherein the weight percent is based on the total weight of the “wet” coating composition.

The polysiloxane resin coating composition may comprise a weight percentage of catalyst from 0.01 wt. %, 0.02 wt. %, 0.05 wt. %, 0.10 wt. % to 1 wt. %, 5 wt. %, 10 wt. %, 20 wt. %, or any range including any two of the foregoing values as endpoints, such as 0.01 wt. % to 20 wt. %, 0.02 wt. % to 10 wt. %, 0.05 wt. % to 5 wt. %, or 0.10 wt. % to 1 wt. %, wherein the weight percent is based on the total weight of the “dry” coating composition.

### C. Solvents

The polysiloxane resin coating composition may comprise a solvent.

Suitable solvents may include xylene, butanol, toluene, methyl ethyl ketone, methyl isobutyl ketone, acetone, butyl acetate, dipropylene glycol monomethyl ether, methoxy propoxy propanol, methoxy propyl acetate, and methyl soy esters. Also, the solvent may include water only, or one or more of the foregoing solvents in combination with water.

The coating composition may comprise a weight percentage of solvents from 10 wt. %, 20 wt. %, 40 wt. % to 60 wt. %, 80 wt. %, 90 wt. %, or any range including any two of the foregoing values as endpoints, such as 10 wt. % to 90 wt. %, 20 wt. % to 80 wt. %, or 40 wt. % to 60 wt. %, wherein the weight percent is based on the total weight of the “wet” coating composition.

The coating composition may comprise a weight percentage of solvents from 0.30 wt. %, 0.50 wt. %, 0.70 wt. % to 0.90 wt. %, 1.10 wt. %, 1.30 wt. %, or any range including any two of the foregoing values as endpoints, such as 0.30 wt. % to 1.30 wt. %, 0.50 wt. % to 1.10 wt. %, or 0.70 wt. % to 0.90 wt. %, wherein the weight percent is based on the total weight of the “dry” coating composition.

### D. Additives

The polysiloxane resin coating composition may comprise additives, such as a catalyst as described above, surface agents, surfactants, pigments, fillers, linear siloxane fluid/silicone oils, and wetting agents.

The coating composition may comprise a total weight percentage of additives from 0.1 wt. %, 0.5 wt. %, 1 wt. % to 5 wt. %, 10 wt. %, 15 wt. %, or any range including any two of the foregoing values as endpoints, such as 0.1 wt. % to 15 wt. %, 0.5 wt. % to 10 wt. %, or 1 wt. % to 5 wt. %, wherein the weight percent is based on the total weight of the “wet” coating composition.

The coating composition may comprise a total weight percentage of additives from 0.50 wt. %, 1 wt. %, 5 wt. % to 10 wt. %, 20 wt. %, 30 wt. %, or any range including any two of the foregoing values as endpoints, such as 0.50 wt. % to 30 wt. %, 1 wt. % to 20 wt. %, or 5 wt. % to 10 wt. %, wherein the weight percent is based on the total weight of the “dry” coating composition.

i. Surfactants

Surfactants may be added to the coating composition in order to enable combination with emulsification filing. Suitable surfactants may include, but are not limited to the following: alkyl sulphates (e.g., sodium lauryl sulphate); ether sulphates; phosphate esters; sulphonates; and their various alkali, ammonium, amine salts; aliphatic alcohol ethoxylates; alkyl phenol ethoxylates (e.g. nonyl phenol polyether); salts and/or combinations thereof.

Surfactants in the coating composition may include non-ionic triblock copolymers. As used herein, a structural unit of triblock copolymer-based non-ionic surfactant refers to a compound of Formula II, below.

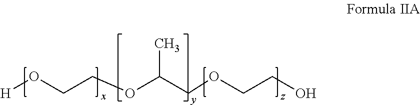

wherein x is an ethylene glycol monomer, y is a propylene glycol monomer, and z is an ethylene glycol monomer.

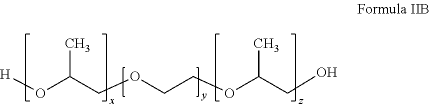

wherein x is a propylene glycol monomer, y is an ethylene glycol monomer, and z is a propylene glycol monomer.

The surfactant of Formula IIA or JIB may be used alone or in combination with other surfactants such as a second triblock-copolymer of formula IIA wherein the ratio of x to y or z to y for the second triblock-copolymer ranges from 0.1:1 to 3:1.

A surfactant of Formula IIA and IIB may have a hydrophilic-lipophilic balance (HLB) value greater than 10, greater than 15, greater than 20, greater than 22, greater than 24, greater than 26, greater than 28, greater than 30, or any range of HLB value using any two of the foregoing values as end points, as determined by using Griffin's method or Davies Method as described in the National Journal of Pharmaceutical Sciences 2021; 1(2): 23-24.

The surfactant of Formula IIA may have an average molecular weight from 8000 g/mol, 10000 g/mol, 12000 g/mol to 14000 g/mol, 14600 g/mol, 15000 g/mol, or any range including any two of the foregoing values as end points, such as 8000 to 15000 g/mol, 10000 to 14600 g/mol, or 12000 to 14000 g/mol, as determined by gel permeation chromatography using polystyrene polymer beads for calibration standards.

The surfactant of Formula IIB may have an average molecular weight from 2000 g/mol, 2500 g/mol, 3000 g/mol to 3500 g/mol, 3700 g/mol, 4000 g/mol, or any range including any two of the foregoing values as end points, such as 2000 to 4000 g/mol, 2500 to 3700 g/mol, or 3000 to 3500 g/mol, as determined by gel permeation chromatography using polystyrene polymer beads for calibration standards.

A structural unit of aliphatic alcohol ethoxylate based non-ionic surfactant may refer to a compound of Formula III, below.

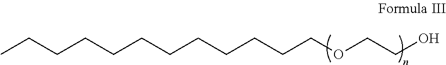

wherein the alkyl chain is C11 to C14 branched or linear alkyl, wherein n=16-18, which has a HLB value greater than 5, greater than 10, greater than 15, or greater than 20, or any range of HLB value using any two of the foregoing values as end points, as determined by using Griffin's method or Davies Method as described in the National Journal of Pharmaceutical Sciences 2021; 1(2): 23-24.

The surfactant of Formula III may be used alone or in combination with other surfactants. The coating composition may comprise a surfactant of Formula III in an amount from 1 wt. %, 2 wt. %, 2.5 wt. % to 3 wt. %, 4 wt. %, 5 wt. %, or any range including two of the foregoing as end points, such as 1 wt. % to 5 wt. %, 2 wt. % to 4 wt. %, or 2.5 wt. % to 3 wt. %, wherein wt. % is based on the total weight of surfactant incorporated per 100 g of emulsion comprising 37-40 g of polysiloxane resin dispersed in it.

The coating composition may comprise a weight percentage of surfactants from 0.01 wt. %, 0.05 wt. %, 0.1 wt. % to 1 wt. %, 5 wt. %, 10 wt. %, or any range including any two of the foregoing values as endpoints, such as 0.01 wt. % to 10 wt. %, 0.05 wt. % to 5 wt. %, or 0.1 wt. % to 1 wt. %, wherein the weight percent is based on the total weight of the “wet” coating composition.

ii. Silicone Oil/Siloxane Fluid

A silicone oil or siloxane fluid may be used as a release agent in the coating composition. The coating composition may include one or more silicone oils or fluids of low molecular weight, medium molecular weight, high molecular weight, or combinations thereof.

A low molecular weight silicone oil may have a molecular weight of less than 8000 g/mol, less than 7000 g/mol, less than 6000 g/mol, less than 5000 g/mol, less than 4000 g/mol, or less than 3000 g/mol, or any value or range encompassed by the foregoing values.

A medium molecular weight silicone oil may have a molecular weight of 12,000 g/mol or greater, 12,500 g/mol or greater, 13,000 g/mol or greater, 13,500 g/mol or less, 14,000 g/mol or less, 14,500 g/mol or less, 15,000 g/mol or less, or any value or range encompassed by the forgoing values.

A high molecular weight silicone oil may have a molecular weight of 90,000 g/mol or greater, 92,000 g/mol or greater, 94,000 g/mol or greater, 96,000 g/mol or less, 98,000 g/mol or less, 100,000 g/mol or less, or any value or range encompassed by the foregoing values.

The coating composition may comprise a weight percentage of silicone oil/siloxane fluid from 0.1 wt. %, 1 wt. %, 5 wt. % to 10 wt. %, 15 wt. %, 20 wt. %, or any range including any two of the foregoing values as endpoints, such as 0.1 wt. % to 20 wt. %, 1 wt. % to 15 wt. %, or 5 wt. % to 10 wt. %, wherein the weight percent is based on the total weight of the “wet” coating composition.

iii. Pigments and Filler

The coating composition may include a pigment. Suitable pigments and/or pigment compositions may include iron oxide, aluminum oxide, mixed metals spinels, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof.

Further, the composition may include a filler. Suitable fillers may include calcium silicate, potassium titanate, aluminum oxide, silicon carbide, kaolin, silica, micas, tale, clays, and inorganic minerals.

The coating composition may comprise a weight percentage of pigments and fillers from 0.1 wt. %, 1 wt. %, 5 wt. % to 10 wt. %, 15 wt. %, 20 wt. %, or any range including any two of the foregoing values as endpoints, such as 0.1 wt. % to 20 wt. %, 1 wt. % to 15 wt. %, or 5 wt. % to 10 wt. %, wherein the weight percent is based on the total weight of the “wet” coating composition.

### E. Application and Curing of Polysiloxane Resin Coating Composition

The polysiloxane resin coating composition may be applied to a substrate/article using a variety of application methods.

Suitable substrates and articles may include metal, die cast aluminum, enamel frit, ceramic, or plastic substrates/articles. Further, substrates/articles that have existing coatings may be suitable substrates for application of the coating composition of the present disclosure.

The coating may be applied to the substrate using vapor deposition, spray coating, roller coating, air-over-knife, or any other suitable coating method. Once applied, the coating composition may be cured at temperatures from 100° C., 200° C., 250° C. to 350, 400° C., 450° C., or any range including any of the foregoing values as endpoints, such as 100° C. to 450° C., 200° C. to 400° C., or 250° C. to 350° C.

### F. Properties of Polysiloxane Resin Coating

The polysiloxane resin coating composition may have improved crack and heat resistance as compared to traditional coating compositions.

i. Fluoropolymers

The coatings of the present disclosure may also be substantially free, essentially free, or completely free of fluorine-containing components.

Fluorine-containing components may include per/polyfluoroalkyl substances (PFAS), such as fluoropolymers, fluorine-containing oligomers and/or fluorine containing small molecules.

By substantially free in relation to fluoropolymers, is meant that the coating composition may comprise less than 5 wt. % of fluoropolymers based on the total weight of the “wet” coating composition. By essentially free in relation to fluoropolymers, is meant that the coating composition may comprise less than 1 wt. % of fluoropolymers based on the total weight of the “wet” coating composition. By completely free in relation to fluoropolymers, is meant that the coating composition may comprise less than 0.01 wt. % of fluoropolymers based on the total weight of the “wet” coating composition.

ii. VOC

In many locations, there are environmental standards to limit the level of VOCs that can be present in coating compositions. VOC are compounds that have a high vapor pressure, generally 10 Pa or more at 20° C., and low water solubility.

The polysiloxane resin coating composition 100a of the present disclosure may comprise minimal VOCs, for example, below the thresholds of the United States Environmental Protection Agency (U.S. EPA) of 3.5 lbs/gal or less and/or the European standard of 420 g/liter. The polysiloxane resin coating composition 100a may comprise an amount of VOCs from less than 200 g/liter, less than 150 g/liter, less than 100 g/liter, less than 50 g/liter, less than 10 g/liter, or less than 5 g/liter, or within any range including any two of the foregoing values as end points, such as 5 g/liter to 200 g/liter, 10 g/liter to 150 g/liter, or 50 g/liter to 100 g/liter.

The polysiloxane resin coating composition may comprise a level of VOCs that is compliant with VOC restrictions of some states. The polysiloxane resin coating composition may comprise an amount of VOCs from less than 370 g/liter, less than 300 g/liter, less than 250 g/liter, less than 200 g/liter, less than 150 g/liter, or less than 100 g/liter, or within any range including any two of the foregoing values as end points, such as 100 g/liter to 370 g/liter, 150 g/liter to 300 g/liter, or 200 g/liter to 250 g/liter.

iii. Initial Crack

Cured coatings may be measured for their initial film cracking on a scale from 1 to 10, as described below in Table 3. A cured coating film may be visually inspected for cracks. The amount of cracking correlates to a numerical value between 1-10, where a rating of 10 has no cracks observable by eye and a rating of 1 is the complete disintegration and disbondment from the substrate.

The amount of cracking may be a function of film thickness. If the coating film has an equal film thickness, the coating film may experience less cracking. The coating composition may have a thickness of 10 μm, 15 μm, 20 μm to 30 μm, 40 μm, 50 μm, or any range including any two of the foregoing values as endpoints, such as 10 μm to 50 μm, 15 μm to 40 μm, or 20 μm to 30 μm. The coating composition of the present disclosure may experience an initial crack rating greater than 7, greater than 8, greater than 9, or 10.

TABLE 3
Initial Crack Scale

| | Initial Crack |
|---|---|
| Film Appearance | Score (1-10) |
| Film disintegration and disbondment | 1 |
| Cracks appear on the film in the oven and the | 2 |
| film delaminates within an hour. | |
| Many large cracks in the film after initial cure. | 3 |
| The film delaminates within 24 hours | |
| Many large cracks present in the film after | 4 |
| initial cure. The film delaminates over a 4-7 | |
| day timespan | |
| Small cracks in the film after initial cure. The | 5 |
| cracks worsen an hour later. No film | |
| delamination. | |
| Small cracks in the film after initial cure. | 6 |
| Cracks worsen over 24 hours. No film | |
| delamination | |
| Small cracks form in the film after initial bake. | 7 |
| Cracks do not worsen. No film delamination | |
| No cracks form in the film during initial bake. | 8 |
| However, multiple cracks form in the film | |
| over 7 days. No film delamination. | |
| No cracks in the film after initial bake. 1-2 | 9 |
| cracks form in the film over 7 days | |
| No cracking of the film noticeable to the | 10 |
| human eye. | |

iv. Thermal Cycles to Failure

The durability of a coating may be tested using a thermal cycling test. Coating composition may be subjected to thermal cycling by heating the coating to 300° C. for one hour and then immediately cooling the coating to 20° C. by submerging the coating in water. Once the coating is cooled, the coating may be dried and inspected for cracks. If no cracks are present, the coating may be heated and cooled again. The number of cycles of heating and cooling that the coating composition can withstand before it cracks may be recorded as the thermal cycles to failure.

Failure occurs when the coating displays a cracking rating of 7 or below according to the initial crack score as described in Table 3, above.

The polysiloxane resin coating of the present disclosure may exhibit a thermal cycle to failure of 6, 7, 8, to 9, 10, 11, or any range including any of the foregoing values as endpoints, such as 6 to 11, 7 to 19, or 8 to 9.

### II. Water Borne Polysiloxane Resin Coating Emulsion

The coating composition emulsion may be formulated by dissolving the polysiloxane resin described above, a co-solvent, and a surfactant or combination of surfactants as described above into water. A “co-solvent” may be an aromatic solvent, such as xylene or toluene; a glycol ether, such as Dowanol PM and Downanol DPM; and water miscible, such as NMP and triethyl phosphate.

The components may be suitably mixed or stirred, such as at 1000 revolutions per minute, (RPM) with a saw-tooth blade or other appropriate mixing method. Solid polysiloxane resin may be first dissolved in solvent before adding the surfactant.

The emulsion may be stirred for a first duration, such as 30 minutes at the first speed and then stirred at a second duration at an increased speed, such as 2000 RPM, with water stabilized at a variable pH (pH of 2-9). The water may be stabilized at a lower pH using acids such as acetic acid, HNO₃, HCl, H₃PO₄, and at a higher pH using organic and inorganic alkali such as triethylamine, dimethylethanolamine, triethanolamine, ammonia, NaOH, KOH, and mixtures thereof. Once the pH stabilized water is added, the emulsion may be stirred for an additional 5 minutes and checked for water dilutability, discussed below.

### A. Water-Dilutability Test

To test how well an emulsion may dilute in water, a water-dilutability test may be performed using the following method. A 1 wt. % polysiloxane resin coating emulsion solution may be prepared by mixing 1 g of polysiloxane resin coating emulsion into 99 g of deionized water. The emulsion solution may be shaken to ensure incorporation of the coating composition into the water. The quality of the solution may be evaluated based on the rating described in Table A, below. The emulsions of the present disclosure has a solution quality evaluation rating of either 3 or 4.

TABLE A
Emulsion Solution Quality Evaluation Rating

| Rating | Description |
|---|---|
| 0 | Emulsion showed instant precipitation of resin particles |
| 1 | Emulsion showed precipitation of resin particles within 5 |
| | minutes |
| 3 | Emulsion showed precipitation of resin particles within 30 |
| | minutes |
| 4 | Emulsion did not show precipitation of resin particles within |
| | 24 hours |

### B. Application and Curing of Polysiloxane Resin Emulsion

The emulsion may be rested overnight and then applied to a substrate/article via a variety of coating application methods.

Suitable substrates and articles may include metal, die cast aluminum, enamel frit, ceramic, or plastic substrates/articles. Further, substrates/articles that have existing coatings may be suitable substrates for application of the coating composition of the present disclosure.

The coating may be applied to the substrate using, spray coating, drawdown coating, vapor deposition, roller coating, air-over-knife, or any other suitable coating method. Once applied to a substrate, the emulsion may be cured.

The coated substrate may be placed in a low temperature oven and baked at a temperature from 100° C., 110° C., 120° C. to 130° C., 140° C., 150° C., or any range including any of the foregoing values as endpoints, such as 100° C. to 150° C., 110° C. to 140° C., or 120° C. to 130° C. The emulsion may be baked for an amount of time from 1 minutes (min), 2 min, 4 min to 6 min, 8 min, 10 min, or any range including any of the foregoing values as endpoints, such as 1 to 10 min. 2 to 8 min, or 4 to 6 min. The coated substrate may then be transferred to a higher temperature oven to bake for an amount of time. The high temperature oven may be at a temperature from 200° C., 250° C., 280° C. to 300° C., 350° C., 400° C., or any range including any of the foregoing values as endpoints, such as 200° C. to 400° C., 250° C. to 250° C., or 280° C. to 300° C. The coated substrate may be baked in the high temperature oven for an amount of time from 10 min, 15 min, 20 min to 25 min, 30 min, 35 min, or any range including any of the foregoing values as endpoints, such as 10 to 35 min, 15 to 30 min, or 20 to 25 min. The coated substrate may then be cooled to room temperature (20-25° C.).

The cured emulsion may have a film thickness on the substrate from 15 μm, 30 μm, 50 μm to 60 μm, 80 μm, 100 μm, or any range including any of the foregoing values as endpoints, such as 15 μm to 100 μm, 30 μm to 80 μm, or 50 μm to 60 μm.

### C. Properties of Polysiloxane Resin Emulsion Coating

The self-life of the polysiloxane resin coating emulsion may be assessed by aging the emulsion at an elevated temperature for a period of time. The stability of the coating composition emulsion may be further tested at 50° C. for phase separation after 24 hours, shear stability after t month, and viscosity at inversion point. The properties of the polysiloxane resin emulsions and emulsion solutions can be seen in Table F. To measure shear stability, a small portion of emulsion (about 0.5 g) aged for one month at 50° C. was placed on a stage of a rheometer (Anton Paar MCR 302e) attached with a cone plate spindle with a cone angle of 0.995°. Subsequently, a shear rate of 1000 s-1 was applied on the sample and appearance of emulsion was inspected, which is described in Table B.

i. Shear Stability

The shear stability test shows the stability of the polysiloxane resin within the emulsion under stress. Poor shear stability may result in buildup of polysiloxane resin particles in the emulsion unevenly across a coated surface.

To test shear stability, an emulsion may be subjected to an elevated temperature and a force, such as a viscometer.

The polysiloxane resin emulsion may have a shear stability greater than 1, greater than 2, or greater than 3 at 50° C., according to the shear stability ratings described in Table B.

TABLE B
Shear Stability Rating for Emulsions

| Rating | Description |
|---|---|
| 0 | Micro-grits/curd like material forms within 10 sec |
| 1 | Micro-grits/curd like material forms within 1-2 min |
| 3 | Micro-grits/curd like material forms within 2-3 min |
| 4 | No micro-grits/curd like material forms within 5 min |

The polysiloxane resin emulsion solution may have a shear stability of 3 or 4, according to the shear stability ratings described in Table C.

TABLE C
Shear Stability Rating for Emulsion Solutions

| Rating | Description |
|---|---|
| 0 | Emulsion showed instant precipitation of resin particles |
| 1 | Emulsion showed precipitation of resin particles within 5 |
| | minutes |
| 3 | Emulsion showed precipitation of resin particles within 30 |
| | minutes |
| 4 | Emulsion did not show precipitation of resin particles within |
| | 24 h |

ii. Phase Separation

The phase separation of a coating composition emulsion may be measured at 50° C. to determine the amount of solvent that has separated from the emulsion after 24 hours. The amount of phase separation may be evaluated based on the rating described in Table D, below. The emulsion of the present disclosure may have a phase separation of 3 or 4.

TABLE D
Phase Separation Ratings

| Rating | Description |
|---|---|
| 0 | Phase separation within 6 h and produce a separate layer of |
| | solvent at top of the emulsion |
| 1 | Phase separation within 24 h and produce a separate layer of |
| | solvent at top of the emulsion |
| 3 | Phase separation within 1-week and produce a separate layer of |
| | solvent at top of the emulsion |
| 4 | No phase separation after 30 days |

iii. Viscosity at Inversion Point

The inversion point of an emulsion is the point at which the emulsion changes from one emulsion type to another, i.e. the emulsion goes from the continuous phase to the dispersed phase. The occurrence of the inversion can often be detected from the increase in viscosity of the emulsion.

To test the viscosity at inversion of the emulsion, a small portion of emulsion (about 0.5 g) at the stage when 40% of the total water is added to the resin, was placed on the stage of a rheometer (Anton Paar MCR 302e) attached with a cone plate spindle with a cone angle of 03.995°. Subsequently, a shear rate of 100 s-1 was applied on the sample and viscosity was measured.

The viscosity at inversion of the emulsion was measured at a shear rate of 100 s-1 using an Anton Paar MCR 302e with a cone plate spindle with a cone angle of 0.995°.

The polysiloxane resin coating emulsion may have a viscosity at inversion point of 3 or 4, based on the rating scale described in Table E.

TABLE E
Viscosity at Inversion Rating

| Rating | Description | |
|---|---|---|
| 0 | >20000 | cps |
| 1 | 10000-20000 | cps |
| 3 | 6000-10000 | cps |
| 4 | 2000-6000 | cps |

TABLE F
Properties of Polysiloxane Resin Coating Emulsion

| | | | Shear | Stability of | |
|---|---|---|---|---|---|
| | | Phase | stability after | 1 wt. % | Viscosity at |
| Polysiloxane | Surfactant | separation | aging at 50 C. | diluted | inversion |
| resin | (wt. %) | after 24 h ¹ | for a month² | emulsion³ | point⁴ |
| Dowsil 0431 | 4.8 | 4 | 4 | 4 | 4 |
| Dowsil 0431 | 1.2 | 3 | 1 | 0 | 4 |
| Dowsil 0431 | 7 | 4 | 4 | 4 | 1 |
| Silres 604 | 2.5 | 4 | 1 | 4 | 4 |
| Silres 604 | 1.2 | 4 | 0 | 0 | 4 |
| Silre 604 | 7 | 4 | 2 | 4 | 1 |

### EXAMPLES

Aspects of the present disclosure are further illustrated by reference to the following examples. It will be apparent to those skilled in the art that many modifications, both to materials, and methods, may be practiced without departing from the scope of the disclosure.

### Example 1: Formation of the Polysiloxane Resin

Inventive (Inv.) and comparative (comp.) polysiloxane resins were prepared according to Table 4 and the procedures set forth below.

### Synthesis of Inventive and Comparative Resins 1-10: Acid Catalysis

To a 500 mL 4-neck flask, attached with an overhead stirrer, a condenser, a N2 inlet and a thermocouple were charged 199.5 g phenyltriethoxysilane, 22.5 g phenylmethyldimethoxysilane, 43.5 g methyltriethoxysilane, 6.8 g diphenyldiethoxysilane and 15 g ethanol. The contents were mixed at room temperature (20-25° C.) and then 0.92 g HCl (37%) was added. 33 g of distilled water was charged over a period of 30 minutes.

The temperature of the reaction mixture raised to 50° C. and held for 1 hour. After that, temperature increased to 70° C. and held for 2 hours while mixing the contents. The reaction then cooled to −30° C. and 4.8 g of NaHCO₃ was added and the contents were mixed for 2 hrs. The solid residues were then filtered. 90 g xylene was added to the filtrate. The lites from the filtrate distilled at 80-120° C. The resin was isolated as 65-85 wt. % solution in xylene.

### Synthesis of Inventive Resins 11-14: Base Catalysis

To a 250 mL 4-neck flask, attached with an overhead stirrer, a condenser, a N2 inlet and a thermocouple charged 100.0 g phenyltrimethoxysilane, 14.0 g phenylmethyldimethoxysilane, 20.0 g methyltrimethoxysilane, 4.0 g diphenyldiethoxysilane and 10 g ethanol. The contents were mixed at room temperature and then 1.15 g ammonium hydroxide (30%) was added. 20.1 g of distilled water was charged over a period of 30 minutes.

The temperature of the reaction mixture raised to 50° C. and held for 1 hour. After that, temperature increased to 70° C. and held for 4 hours while mixing the contents. 45 g xylene was added. The lites from the filtrate distilled at 80-120° C. The resin was isolated as 65-85 wt % solution in xylene.

The comparative resins were synthesized using similar procedures.

TABLE 4
Polysiloxane Resins

| | | | | | Degree of | | | |
|---|---|---|---|---|---|---|---|---|
| | PhSiO_{3/2} | MeSiO_{3/2} | PhMeSiO | Ph₂SiO | Substitution | | | |
| Resin # | (mole %) | (mole %) | (mole %) | (mole %) | on Si: R/Si | Ph/Si | Me/Ph | GPC M_{w} |
| Inv. | 68.0 | 20.0 | 10.0 | 2.0 | 1.1 | 0.82 | 0.37 | 1781 |
| Resin 1 | | | | | | | | |
| Comp. | 50.0 | 50.0 | 0.0 | 0.0 | 1.0 | 0.50 | 1.00 | 15899 |
| Resin 2 | | | | | | | | |
| Comp. | 80.0 | 20.0 | 0.0 | 0.0 | 1.0 | 0.80 | 0.25 | 4199 |
| Resin 3 | | | | | | | | |
| Comp. | 50.0 | 50.0 | 0.0 | 0.0 | 1.0 | 0.50 | 1.00 | 4538 |
| Resin 4 | | | | | | | | |
| Comp. | 80.0 | 20.0 | 0.0 | 0.0 | 1.0 | 0.80 | 0.25 | 1758 |
| Resin 5 | | | | | | | | |
| Comp. | 61.8 | 26.3 | 10.0 | 2.0 | 1.1 | 0.76 | 0.48 | 2301 |
| Resin-6 | | | | | | | | |
| Inv. | 70.0 | 20.0 | 10.0 | 0.0 | 1.1 | 0.80 | 0.38 | 1678 |
| Resin 7 | | | | | | | | |
| Comp. | 63.8 | 26.3 | 10.0 | 0.0 | 1.1 | 0.74 | 0.49 | 2187 |
| Resin 8 | | | | | | | | |
| Inv. | 75 | 15 | 10 | 0 | 1.1 | 0.85 | 0.29 | 1797 |
| Resin 9 | | | | | | | | |
| Inv. | 77.5 | 17.5 | 5 | 0 | 1.05 | 0.83 | 0.27 | 1795 |
| Resin 10 | | | | | | | | |
| Inv. | 68.0 | 20.0 | 10.0 | 2.0 | 1.1 | 0.82 | 0.37 | 2281 |
| Resin 11 | | | | | | | | |
| Inv. | 70 | 15 | 13 | 2 | 1.2 | 0.87 | 0.32 | 2025 |
| Resin 12 | | | | | | | | |
| Inv. | 50 | 15 | 25 | 10 | 1.35 | 0.95 | 0.42 | 1724 |
| Resin 13 | | | | | | | | |
| Inv. | 74 | 16 | 8 | 2 | 1.1 | 0.86 | 0.27 | 1935 |
| Resin 14 | | | | | | | | |

### Example 2: Preparation of the Solvent Borne Polysiloxane Coating Compositions

Example (Ex.) solvent borne coating compositions of the present disclosure and comparative (comp.) coating compositions were prepared according to Tables 5 and 6.

Solvent borne coatings were formulated by adding materials, in the order listed, under medium stirring with a saw tooth blade. The polysiloxane resin solution is added, followed by a 2% solution of tin (II) 2 ethyl hexanoate, a condensation catalyst. Next is added the BYK-333 as a wetting agent, and optionally additional xylene to adjust solids.

The fully formulated solutions were stirred for 5-10 minutes then applied by draw down using a wire-wound bar (#8) on 3003 series aluminum (Q412) available from Q-Lab. Coatings were placed in a 120° C. oven for 10 minutes then transferred to a 300° C. oven and heated for 20 minutes. Coatings were cooled at room temperature and the film thickness was 15-30 μm.

All coating compositions listed in Table 5 contain the same wt. % of dry polysiloxane resin. Solvent was added to Ex. 1-4 and Comp. 5-6 to maintain the same wt. % solids as Comp. 1-4, in which the resins contain more solvent.

TABLE 5
Coating Compositions with Acid Catalyzed Resins

| | | | | | Comp. | Comp. | Comp. | Comp. | Comp. | Comp. |
|---|---|---|---|---|---|---|---|---|---|---|
| | Ex. 1 | Ex. 2 | Ex. 3 | Ex. 4 | 1 | 2 | 3 | 4 | 5 | 6 |
| | Mass | Mass | Mass | Mass | Mass | Mass | Mass | Mass | Mass | Mass |
| Component | (g) | (g) | (g) | (g) | (g) | (g) | (g) | (g) | (g) | (g) |
| Comp. Resin-2 | | | | | 99.01 | | | | | |
| Comp. Resin-3 | | | | | | 99.01 | | | | |
| Comp. Resin-4 | | | | | | | 99.01 | | | |
| Comp. Resin-5 | | | | | | | | 99.01 | | |
| Inv. Resin-1 | 73.15 | | | | | | | | | |
| Comp. Resin-6 | | | | | | | | | 70.32 | |
| Inv. Resin-7 | | 75.08 | | | | | | | | |
| Comp. Resin-8 | | | | | | | | | | 71.58 |
| Inv. Resin 9 | | | 76.06 | | | | | | | |
| Inv. Resin 10 | | | | 78.06 | | | | | | |
| Solution of 2% | 0.88 | 0.9 | 0.43 | 0.43 | 0.99 | 0.99 | 0.99 | 0.99 | 0.84 | 0.86 |
| tinethylhexanoate | | | | | | | | | | |
| in xylene | | | | | | | | | | |
| BYK-333 | 0.73 | 0.75 | 0.43 | 0.43 | | | | | 0.7 | 0.72 |
| Xylene | 25.24 | 23.27 | 21.8 | 21.8 | | | | | 28.13 | 26.84 |

TABLE 6
Coating Compositions with Base Catalyzed Resins

| | Ex. 5 | Ex. 6 | Ex. 7 |
|---|---|---|---|
| Inv. Resin-11 | | | 71.89 |
| Inv. Resin-12 | 70.72 | | |
| Inv. Resin-13 | | 75.99 | |
| Solution of 2% tinethylhexanoate in xylene | 0.50 | 0.61 | 0.58 |
| BYK-333 | 0.50 | 0.61 | 0.58 |
| Xylene | 28.29 | 22.80 | 26.96 |

### Example 3: Preparation of Water Borne Polysiloxane Resin Coating Emulsions

Example (Ex.) polysiloxane resin coating emulsions of the present disclosure were prepared according to Tables 7 and 8.

The polysiloxane resin coating emulsions were formulated by adding the resin solution, any additional co-solvent, and the surfactant, or combination of surfactants, under stirring at 1000 RPM with a saw-tooth blade. If the resin was solid, it was dissolved first in solvent before adding the surfactant. Stirring continued for 30 minutes. After 30 minutes, stirring was increased to 2000 RPM and a 0.23% solution of ammonia in water was added in approximately 3 g portions. Each portion was added as rapidly in a single shot. Once all the basic water was added, the emulsion was stirred for an additional 5 minutes and checked for water dilutability.

One gram of polysiloxane resin coating emulsion was added to a 20 mL jar and then 6 g of Deionized water was added. The dilution was shaken to ensure incorporation. The formulation passes if the product is a free flowing white dispersion throughout the dilution. The formulation fails if the white emulsion does not incorporate into the water, but sits as a separate phase.

The formulations were allowed to rest overnight and then applied by spray or drawdown methods on 3003 series aluminum (Q412) available from Q-Lab. The coatings were placed in a 120° C. oven for 1-10 minutes, and then transferred to a 300° C. oven for 20 minutes. The coatings were cooled to room temperature and the film thickness was 15-30 um.

TABLE 7
Coating Composition Emulsions with Acid Catalyzed Resins

| Component | Ex. 8 |
|---|---|
| Inv. Resin-14 | 57.33 |
| Poly(ethylene glycol) (18) tridecyl ether | 5.36 |
| Ammonium hydroxide 0.225% | 37.31 |

TABLE 8
Coating Composition Emulsions with Base Catalyzed Resins

| Component | Ex. 9 | Ex. 10 | Ex. 11 | Ex. 12 | Ex. 13 |
|---|---|---|---|---|---|
| Inv. Resin-11 | 60.23 | | | | |
| Inv. Resin-12 | | 56.47 | | | |
| Inv. Resin-13 | | | 61.26 | 53.75 | 53.37 |
| Dowanol DPM | | | | 4.89 | 3.81 |
| Poly(ethylene glycol) (18) | 5.22 | 5.11 | 4.54 | 2.28 | 0 |
| tridecyl ether | | | | | |
| Pluronic F108 | | | | 3.26 | 5.08 |
| Ammonium hydroxide | 34.55 | 38.42 | 34.20 | | |
| solution 0.225% | | | | | |
| Di water | | | | 35.83 | 37.74 |

### Example 4: Polysiloxane Resin Emulsion with Pluronic F108

The polysiloxane resin emulsions were prepared according to Table 9.

The following commercial resins were used to create the emulsions: Silres 604, Dowanol RSN 0233, Dowanol RSN 0220, and Dowanol RSN 0431.

Non-ionic surfactant (Pluoronic F108; CAS-No.: 691397-13-4) and solvent (Dowanol DPM) were blended together using a high shear dispersion blade (1″ Dia. X 1/4″ Center Hole Type A 316 SS Dispersion Blade) until a homogeneous solution was obtained. Then, a separate aqueous solution comprising dissolved ammonia (0.75 g of 30% ammonium hydroxide in 100 g of de-ionized water), stabilized at pH 10 was incorporated into the abovementioned resin solution in a stepwise manner. The water addition was split into 10-parts (3 g each; 10% of total water) and after each addition a gap of one-minute interval was maintained. After complete addition of water, the emulsion was stirred for another 15 minutes.

TABLE 9
Coating Emulsions

| | | Ex. 14 | Ex. 15 |
|---|---|---|---|
| Material | Description | Mass (g) | |
| Commercial | Methyl phenyl | 39.76 | 0 |
| polysiloxane resin¹ | polysiloxane resin | | |
| Commercial | Methyl phenyl | 0 | 49.64 |
| polysiloxane resin² | polysiloxane resin | | |
| Dowanol DPM | Solvent | 21.69 | 21.69 |
| Pluronic F 108 | Surfactant/emulsifier | 2.41 | 2.41 |
| Ammonium | Alkali | 0.27 | 0.27 |
| Hydroxide 30% | | | |
| DI water | Water | 35.87 | 35.87 |

¹For Silres 604, Dowsil RSN 0233, Dowsil RSN 0220, the polysiloxane resin is a solvent free solid flake powder.
²For Dowsil RSN 0431, the polysiloxane resin is a mixture of solvent (20%) and resin (80%) dissolved within the solvent.

### Example 5: Properties of Coating Compositions

The properties of cured coating compositions of the present disclosure and comparative coating compositions were recorded as shown in Table 10.

Once cured, the initial film cracking of the coating compositions was measured by visual rating on a 10-1 scale. Cracking was found to be a function of film thickness and maintaining equal film thicknesses is essential.

Coatings that had initial cracking ratings of 10 were further tested for durability to thermal cycling. The coatings were placed in a 300° C. oven for 1 hour then immediately cooled by submersion in water. The coatings were then dried and inspected for cracks. If no cracks developed, they were placed back in the oven for another cycle. The number of cycles at which cracks developed was taken as the performance metric with higher numbers indicating better performance.

TABLE 10
Properties of Coating Compositions

| | Performance data | | | Resin composition ratios | | | |
|---|---|---|---|---|---|---|---|
| | Initial | Thermal | | Alkyl + | | | |
| | crack | cycles at | Water- | Aryl/Si | Ph/Si | Me/Ph | DMePh |
| Example | rating | failure | Dilutable | ratio | ratio | ratio | mol % |
| Ex. 1 | 10 | 9 | | 1.1 | 0.8 | 0.4 | 10 |
| Ex. 2 | 10 | 9 | | 1.1 | 0.8 | 0.4 | 10 |
| Ex. 3 | 10 | 5 | | 1.1 | 0.9 | 0.3 | 10 |
| Ex. 4 | 10 | 7 | | 1.1 | 0.8 | 0.3 | 5 |
| Comp. 1 | 8 | | | 1 | 0.8 | 0.3 | 0 |
| Comp. 2 | 5 | | | 1 | 0.8 | 0.3 | 0 |
| Comp. 3 | 2 | | | 1 | 0.5 | 1.0 | 0 |
| Comp. 4 | 10 | 3 | | 1.1 | 0.8 | 0.5 | 10 |
| Ex. 5 | 10 | 4 | | 1.1 | 0.8 | 0.4 | 10 |
| Ex. 6 | 10 | 13 | | 1.2 | 0.9 | 0.3 | 13 |
| Ex. 7 | 10 | 4 | | 1.4 | 1.0 | 0.4 | 25 |
| Ex. 8 | 10 | 6 | Yes | 1.1 | 0.9 | 0.3 | 8 |
| Ex. 9 | 10 | 6 | Yes | 1.1 | 0.8 | 0.4 | 10 |
| Ex. 10 | 10 | 8 | Yes | 1.2 | 0.9 | 0.3 | 13 |
| Ex. 11 | 10 | 16 | Yes | 1.4 | 1.0 | 0.4 | 25 |
| Ex. 12 | 10 | 17 | Yes | 1.4 | 1.0 | 0.4 | 25 |
| Ex. 13 | 10 | 22 | Yes | 1.4 | 1.0 | 0.4 | 25 |
| Ex. 14^{a} | 5 | 0 | Yes | | | 1^{e} | |
| Ex. 14^{b} | 10 | 2 | Yes | 1.15^{e} | | 0.77^{e} | |
| Ex.14^{c} | 10 | 10 | Yes | 1.2^{e} | | 0.5^{e} | |
| Ex. 15^{d} | 10 | 22 | Yes | 1.4^{e} | | 0.83^{e} | |

^{a}Silres 604 available from Wacker Chemie;
^{b}Dowsil RSN-0233 available from Dow Silicones;
^{c}Dowsil RSN-0220 available from Dow Silicones;
^{d}Dowsil RSN-0431 available from Dow Silicones;
^{e}Information from technical data sheet

The example coating compositions of the present disclosure (Ex. 1-4) and comparative coating compositions (Comp. 1-4) show a range of performance with respect to initial crack rating and Thermal Cycles at failure even though the coatings all possess an alkyl/silicon atomic ratio of 1-1.2. The mixed performance demonstrates this range, which is known in the art, is not indicative of thermal resistance which is the invention described here.

Ex. 1-3 coating compositions contain a resins which possesses 10 mole % of a PhMeSiO monomer, a Ph/silicone molar ratio greater than 0.8, a methyl/phenyl molar ratio of less than 0.4, and 50-75% of the SiOR converted to SiOH or SiOSi during synthesis. Ex. 4 is similar to Ex. 1-3 compositions except Ex. 4 possesses 5 mole % of a PhMeSiO monomer.

The coating compositions of the present disclosure all (Ex. 1-4) had excellent crack resistance, as seen by the initial crack ratings. Further, coating compositions Ex. 1 and Ex. 2 survived 9 thermal cycles, coating composition Ex. 3 survived 5 thermal cycles, and coating composition Ex. 4 survived 7 thermal cycles. All coating compositions of the present disclosure survived an increased amount of thermal cycles as compared to comparative coating 4 (Comp. 4) which only survived 3 thermal cycles before failure.

Comparative coating 1 (Comp. 1) shows the importance of the PhMeSiO monomer. Without at least 5% of this monomer the coatings fail to pass the initial crack test.

Comparative coating 2 (Comp. 2) shows the additive effect of SiOR conversion with PhMeSiO monomer. Comp. 2 did not achieve an initial crack rating of 10 and had even worse initial cracking than Comp. 1.

Comparative coating 3 (Comp. 3) shows the additive effect of PhMeSiO monomer, Ph/silicone molar ratio, a methyl/phenyl molar ratio, SiOR conversion. While Comps. 1-3 all had initial crack ratings out of the inventive range (10), Comp. 3 had the worst initial crack rating.

Comparative coating 4 (Comp. 4) shows a coating with a Ph/silicone molar ratio and an alkyl/silicone molar ratio within the inventive ranges, but a methyl/phenyl molar ratio greater than the inventive ranges, the coating passes the initial crack rating but has poor performance in the thermal cycling test.

Coating composition examples 5-7 of the present disclosure show that the base-catalyzed resins perform similar to the acid catalyzed resins if the resin structure falls in the inventive ranges. Example 8 shows that the acid catalyzed resins can form water dilutable coating compositions with thermal durability after application if the resin is in the inventive ranges.

Coating emulsions examples 9-11 of the present disclosure show that base catalyzed resins can form water dilutable coating composition with thermal durability after application if the resin is within the inventive ranges.

Example coating emulsions 11, 12, and 13 demonstrate that the surfactants of Formula II and Formula III can be used alone or in combination without impacting the water dilatability or the thermal performance of the final coating.

Example coating emulsions 14 and 15 in Table 11 describe the quality of the emulsions and the thermal cycling performance rating of coatings derived from emulsions made with commercial polysiloxane resins. The correlation of ratings and thermal resistance is described in Table 3, vide supra. All resins showed water dilatability, however, it was observed that emulsions made with Dowsil 0431 (Ex. 15d) achieved the maximum thermal shock resistance, which was found to be 22-thermal cycles exposure.

Wherein particular examples of this invention have been described above for purposes of illustration, it will be evident to those skilled in the art that numerous variations of the details of the present invention may be made without departing from the invention as defined in the appended claims. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

### Aspects

Aspect 1 is a curable coating composition, comprising: a polysiloxane resin formed from siloxane monomers: [R¹Si(O)_{3/2}]x; [R²R³Si(O)]_{y}; and [R⁴Si(O)_{3/2}]_{z}; wherein: x is any integer from 1 to 50; y is any integer from 1 to 20; z is any integer from 1 to 50; R¹ is a C₁-C₃₀ linear or C₃-C₃₀ cyclic alkyl group; R² and R³ are each independently a C₁-C₃₀ linear or C₃-C₃₀ cyclic alkyl group, or a C₆ or C₇ aryl group; R⁴ is a C₆ or C₇ aryl group; and a solvent; wherein the composition comprises less than 5 wt. % of any fluorine-containing component, based on a total weight of the composition.

Aspect 2 is the composition of aspect 1, further comprising a condensation catalyst.

Aspect 3 is the composition of any one of aspect 1 or aspect 2, wherein the polysiloxane resin comprises aryl groups, and comprises a mole ratio of aryl groups to silicon atoms of 0.8 or greater, based on total moles of aryl groups divided by total moles of silicon atoms based on mol % percent of monomers from which the polysiloxane resin is formed.

Aspect 4 is the composition of any one of aspects 1-3, wherein the polysiloxane resin comprises phenyl groups, and comprises a mole ratio of phenyl groups to silicon atoms of 0.8 or greater, based on total moles of phenyl groups divided by total moles of silicon atoms based on mol % of monomers from which the polysiloxane resin is formed.

Aspect 5 is the composition of any one of aspects 1-4, wherein the polysiloxane resin comprises phenyl groups, and further wherein: a molar amount of monomer [R⁴Si(O)_{3/2]}_{z} is greater than 60 mol % based on mol % of monomers from which the polysiloxane resin is formed; and a molar amount of component [R²R³Si(O)]_{y} is from 5 mol % to 30 mol % based on a total molar mass of the polysiloxane resin.

Aspect 6 is the is the composition of any one of aspects 1-5, wherein the polysiloxane resin comprises phenyl groups, and further wherein: a molar amount of component [R⁴Si(O)_{3/2]}_{z} is greater than 65% based on a total molar mass of the polysiloxane resin; and a molar amount of component [R²R³Si(O)]_{y} is from 5% to 10% based on a total molar mass of the polysiloxane resin.

Aspect 7 is the composition of any one of aspects 1-6, wherein the polysiloxane resin comprises alkyl groups and aryl groups and comprises a mole ratio of alkyl groups to aryl groups of 0.45 or less, based on total moles of alkyl groups divided by total moles of aryl atoms based on mol % of monomers from which the polysiloxane resin is formed.

Aspect 8 is the composition of any one of aspects 1-7, wherein the polysiloxane resin comprises methyl groups and phenyl groups and comprises a mole ratio of methyl groups to phenyl groups of 0.45 or less, based on total moles of methyl groups divided by total moles of phenyl atoms based on mol % of monomers from which the polysiloxane resin is formed.

Aspect 9 is the composition of any one of aspects 1-8, wherein the polysiloxane resin comprises monomer residues of each of the following siloxane monomers: phenyltrialkoxy silane; phenylmethyldialkoxy silane; methyltrialkoxy silane; and diphenyldialkoxy silane.

Aspect 10 an article coated with the coating composition of any one of aspects 1-9.

Aspect 11 is the article of aspect 10, wherein the article is at least one of a metal, die cast aluminum, enamel frit, ceramic, plastic, and pre-coated article.

Aspect 12 is a method of coating a substrate, comprising: applying, to a substrate, a coating composition comprising: a polysiloxane resin formed from siloxane monomers: [R¹Si(O)_{3/2}]ₓ; [R²R³Si(O)]_{y}; and [R⁴Si(O)_{3/2]}_{z}; wherein: x is any integer from 1 to 50; y is any integer from 1 to 20; z is any integer from 1 to 50; R¹ is a C₁-C₃₀ linear or C₃-C₃₀ cyclic alkyl group; R² and R³ are each independently a C₁-C₃₀ linear or C₃-C₃₀ cyclic alkyl group, or a C₆ or C₇ aryl group; R⁴ is a C₆ or C₇ aryl group; and a solvent; wherein the composition comprises less than 5 wt. % of any fluorine-containing component, based on a total weight of the composition; and curing the coating composition.

Aspect 13 is the method of aspect 12, wherein the coating composition further comprises a condensation catalyst.

Aspect 14 is the method of either claim 12 or claim 13, wherein the polysiloxane resin comprises aryl groups, and comprises a mole ratio of aryl groups to silicon atoms of 0.8 or greater, based on total moles of aryl groups divided by total moles of silicon atoms based on mol % of monomers from which the polysiloxane resin is formed.

Aspect 15 is the method of any one of aspects 12-14, wherein the polysiloxane resin comprises phenyl groups, and comprises a mole ratio of phenyl groups to silicon atoms of 0.8 or greater, based on total moles of phenyl groups divided by total moles of silicon atoms based on mol % of monomers from which the polysiloxane resin is formed.

Aspect 16 is the method of any one of aspects 12-15, wherein the polysiloxane resin comprises phenyl groups, and further wherein: a molar amount of component [R⁴Si(O)3/2]z is greater than 60 mol % based on a total molar mass of the polysiloxane resin; and a molar amount of component [R²R³Si(O)]_{y} is from 5 mol % to 10 mol % based on a total molar mass of the polysiloxane resin.

Aspect 17 is the method of any one of aspects 12-16, wherein the polysiloxane resin comprises phenyl groups, and further wherein: a molar amount of component [R⁴Si(O)₃/2]z is greater than 65% based on a total molar mass of the polysiloxane resin; and a molar amount of component [R²R³Si(O)]y is from 5% to 10% based on a total molar mass of the polysiloxane resin.

Aspect 18 is the method of any one of aspects 12-17, wherein the polysiloxane resin comprises alkyl groups and aryl groups and comprises a mole ratio of alkyl groups to aryl groups of 0.45 or less, based on total moles of alkyl groups divided by total moles of aryl atoms based on mol % of monomers from which the polysiloxane resin is formed.

Aspect 19 is the method of any one of aspects 12-18, wherein the polysiloxane resin comprises methyl groups and phenyl groups and comprises a mole ratio of methyl groups to phenyl groups of 0.45 or less, based on total moles of methyl groups divided by total moles of phenyl atoms based on mol % of monomers from which the polysiloxane resin is formed.

Aspect 20 is the method of any one of aspects 12-19, wherein the polysiloxane resin comprises monomer residues of each of the following siloxane monomers: phenyltrialkoxy silane; phenylmethyldialkoxy silane; methyltrialkoxy silane; and diphenyldialkoxy silane.

Aspect 21 is the method of any one of aspects 12-20, wherein the substrate is at least one of a metal, die cast aluminum, enamel frit, ceramic, plastic, and pre-coated substrate.

Aspect 22 is a curable composition comprising: a polysiloxane resin formed from siloxane monomer units; wherein the polysiloxane resin comprises less than 80 mol % of T siloxane monomer units, based on the total moles of siloxane monomer units in the polysiloxane resin; wherein the polysiloxane resin comprises less than 1 mol % of M and Q siloxane monomer units, based on the total moles of siloxane monomer units in the polysiloxane resin; a solvent; and a surfactant; wherein the surfactant comprises at least one of: a surfactant of Formula IIA

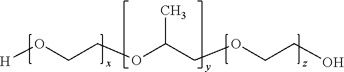

wherein x is an ethylene glycol monomer, y is a propylene glycol monomer and z is an ethylene glycol monomer; a surfactant of Formula JIB

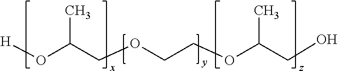

wherein x is a propylene glycol monomer, y is an ethylene glycol monomer, and z is propylene glycol monomer; a surfactant of Formula III

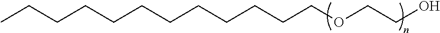

wherein n=16-20; and a combination of surfactants of Formula IIA, IIB, and III; and wherein a weight ratio of the surfactant to the polysiloxane resin is from 0.01 to 0.09 based on the total weight of the composition; and wherein the composition includes less than 1 wt. % of any fluorine-containing component, based on a total weight of the composition.

Aspect 23 is the curable composition of aspect 22, further comprising a condensation catalyst.

Aspect 24 is the curable composition of aspect 22 or aspect 23, wherein the polysiloxane resin comprises alkyl groups and aryl groups and comprises a mole ratio of alkyl groups to aryl groups of 1 or less, based on total moles of alkyl groups divided by total moles of aryl atoms based on mol % of monomers from which the polysiloxane resin is formed.

Aspect 25 is the curable composition of any one of claims 22-24, wherein the surfactant of Formula IIA may have an average molecular weight from 8000 g/mol to 15,000 g/mol.

Aspect 26 is the curable composition of any one of claims 22-25, wherein the surfactant has a hydrophilic-lipophilic balance (HLB) value of 15-27, as determined using Griffin's method or Davies Method.

Aspect 27 is the curable composition of any one of claims 22-26, wherein the solvent comprises a first solvent and a second solvent, the first solvent comprises at least one of xylene, butanol, toluene, methyl ethyl ketone, methyl isobutyl ketone, acetone, butyl acetate, dipropylene glycol monomethyl ether, the second solvent comprises water.

Aspect 28 is the curable composition of any one of claims 22-27, wherein the curable composition is dilutable in water.

Aspect 29 is the curable composition of any one of claims 22-28, wherein the polysiloxane resin further comprises: a molar ratio of a sum of alkyl and aryl to Si of 1.1 to 1.4; a molar ratio of methyl to phenyl groups of 0.4 to 1.

Aspect 30 is the curable composition of any one of claims 22-29, further comprising a second surfactant of Formula IIA, wherein at least one of the ratios x to y or z to y for the second surfactant is from 0.1:1 to 3:1.

Aspect 31 is an article coated with the coating composition of any one of aspects 22-30.

Aspect 32 is the article of aspect 31, wherein the article is at least one of a metal, die cast aluminum, enamel frit, ceramic, plastic, and pre-coated article.

Aspect 33 is a method of coating a substrate, comprising: applying, to a substrate, a coating composition comprising: a polysiloxane resin formed from siloxane monomer units and having the following formula: RₙSiO((4-n)/2), wherein R is alkyl or aryl; wherein the polysiloxane resin comprises less than 80 mol % of T siloxane monomer units, based on the total moles of siloxane monomer units in the polysiloxane resin; wherein the polysiloxane resin comprises less than 1 mol % of M and Q siloxane monomer units, based on the total moles of siloxane monomer units in the polysiloxane resin; a solvent; and a surfactant; wherein the surfactant comprises at least one of: a surfactant of Formula IIA

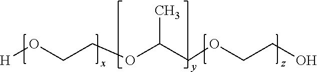

wherein x is an ethylene glycol monomer, y is a propylene glycol monomer and z is an ethylene glycol monomer; a surfactant of Formula IIB

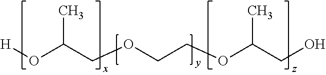

wherein x is a propylene glycol monomer, y is an ethylene glycol monomer, and z is propylene glycol monomer; a surfactant of Formula III

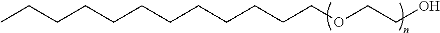

wherein n=16-20; and a combination of surfactants of Formula IIA, IIB, and III; and wherein a weight ratio of the surfactant to the polysiloxane resin is from 0.01 to 0.09, based on the total weight of the coating composition; and curing the coating composition.

Aspect 34 is the method of aspect 33, wherein the coating composition further comprises a condensation catalyst.

Aspect 35 is the method of aspect 33 or aspect 34, wherein before applying the coating composition to the substrate, the coating composition is diluted with water.

Aspect 36 is the method of any one of aspects 33-35, wherein the surfactant has an average molecular weight of 8000 g/mol to 15,000 g/mol and a hydrophilic-lipophilic balance (HLB) value greater than 10, as determined using Griffin's method or Davies Method.

Aspect 37 is the method of any one of aspects 33-36, wherein the polysiloxane resin further comprises: a ratio of alkyl to Si of 1.1 to 1.4; a ratio of methyl to phenyl groups of 0.4 to 1.

Aspect 38 is the method of any one of aspects 33-37, wherein the substrate is at least one of a metal, die cast aluminum, enamel frit, ceramic, plastic, or pre-coated substrate.

Aspect 39 is a polysiloxane resin formed from siloxane monomer units: [R¹Si(O)_{3/2}]x; [R²R³Si(O)]_{y}; [R⁴Si(O)_{3/2}]_{z}; wherein: x is any integer from 1 to 50; y is any integer from 1 to 20; z is any integer from 1 to 50; R¹ is a C₁-C₃₀ linear or C₃-C₃₀ cyclic alkyl group; R² and R³ are each independently a C₁-C₃₀ linear or C₃-C₃₀ cyclic alkyl group, or a C₆ or C₇ aryl group; and R⁴ is a C₆ or C₇ aryl group; wherein the polysiloxane resin comprises less than 80 mol % of T siloxane monomer units, based on the total moles of siloxane monomer units in the polysiloxane resin; wherein the polysiloxane resin comprises less than 1 mol % of M and Q siloxane monomer units, based on the total moles of siloxane monomer units in the polysiloxane resin.

Aspect 40 is the polysiloxane resin of aspect 39, wherein the polysiloxane resin comprises aryl groups, and comprises a mole ratio of aryl groups to silicon atoms of 0.8 or greater, based on total moles of aryl groups divided by total moles of silicon atoms based on mol % of monomers from which the polysiloxane resin is formed.

Aspect 41 is the polysiloxane resin of either aspect 39 or aspect 40, wherein the polysiloxane resin comprises phenyl groups, and comprises a mole ratio of phenyl groups to silicon atoms of 0.8 or greater, based on total moles of phenyl groups divided by total moles of silicon atoms based on mol % of monomers from which the polysiloxane resin is formed.

Aspect 42 is the polysiloxane resin of any one of aspects 39-41, wherein the polysiloxane resin comprises phenyl groups, and further wherein: a molar amount of monomer [R⁴Si(O)3/2]z is greater than 60 mol % based on mol % of monomers from which the polysiloxane resin is formed; and a molar amount of component [R²R³Si(O)]y is from 5 mol % to 30 mol % based on a total molar mass of the polysiloxane resin.

Aspect 43 is the polysiloxane resin of any one of aspects 39-42, wherein the polysiloxane resin comprises phenyl groups, and further wherein: a molar amount of component [R⁴Si(O)3/2]z is greater than 65% based on a total molar mass of the polysiloxane resin; and a molar amount of component [R²R³Si(O)]y is from 5% to 10% based on a total molar mass of the polysiloxane resin.

Aspect 44 is the polysiloxane resin of any one of aspects 39-43, wherein the polysiloxane resin comprises alkyl groups and aryl groups and comprises a mole ratio of alkyl groups to aryl groups of 0.45 or less, based on total moles of alkyl groups divided by total moles of aryl atoms based on mol % of monomers from which the polysiloxane resin is formed.

Aspect 45 is the polysiloxane resin of any one of aspects 39-44, wherein the polysiloxane resin comprises methyl groups and phenyl groups and comprises a mole ratio of methyl groups to phenyl groups of 0.45 or less, based on total moles of methyl groups divided by total moles of phenyl atoms based on mol % of monomers from which the polysiloxane resin is formed.

Aspect 46 is the polysiloxane resin of any one of aspects 39-45, wherein the polysiloxane resin comprises monomer residues of each of the following siloxane monomers: phenyltrialkoxy silane; phenylmethyldialkoxy silane; methyltrialkoxy silane; and diphenyldialkoxy silane.

Aspect 47 is the polysiloxane resin of any one of aspects 39-46, wherein the polysiloxane resin further comprises a solvent in an amount from 5-35 wt. %, based on the total weight of the polysiloxane resin.

1.-21. (canceled)

22. A curable composition comprising:
a polysiloxane resin formed from siloxane monomer units;
wherein the polysiloxane resin comprises less than 80 mol % of T siloxane monomer units, based on the total moles of siloxane monomer units in the polysiloxane resin;
wherein the polysiloxane resin comprises less than 1 mol % of M and Q siloxane monomer units, based on the total moles of siloxane monomer units in the polysiloxane resin;
a solvent; and
a surfactant;
wherein the surfactant comprises at least one of:
a surfactant of Formula IIA 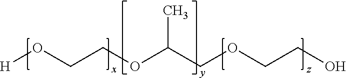
wherein x is an ethylene glycol monomer, y is a propylene glycol monomer and z is an ethylene glycol monomer;
a surfactant of Formula IIB 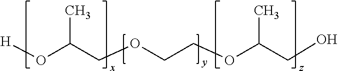
wherein x is a propylene glycol monomer, y is an ethylene glycol monomer, and z is propylene glycol monomer;
a surfactant of Formula III 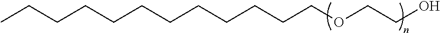
wherein n=16-20; and
a combination of surfactants of Formula IIA, IIB, and III; and
wherein a weight ratio of the surfactant to the polysiloxane resin is from 0.01 to 0.09 based on the total weight of the composition; and
wherein the composition includes less than 1 wt. % of any fluorine-containing component, based on a total weight of the composition.

23. The curable composition of claim 22 further comprising a condensation catalyst.

24. The curable composition of claim 22, wherein the polysiloxane resin comprises alkyl groups and aryl groups and comprises a mole ratio of alkyl groups to aryl groups of 1 or less, based on total moles of alkyl groups divided by total moles of aryl atoms based on mol % of monomers from which the polysiloxane resin is formed.

25. The curable composition of claim 22, wherein the surfactant of Formula IIA may have an average molecular weight from 8000 g/mol to 15,000 g/mol; and
wherein the surfactant has a hydrophilic-lipophilic balance (HLB) value of 15-27, as determined using Griffin's method or Davies Method.

26. (canceled)

27. The curable composition of claim 22, wherein the solvent comprises a first solvent and a second solvent, the first solvent comprises at least one of xylene, butanol, toluene, methyl ethyl ketone, methyl isobutyl ketone, acetone, butyl acetate, dipropylene glycol monomethyl ether, the second solvent comprises water.

28. (canceled)

29. The curable composition of claim 22, wherein the polysiloxane resin further comprises:
a molar ratio of a sum of alkyl and aryl to Si of 1.1 to 1.4;
a molar ratio of methyl to phenyl groups of 0.4 to 1.

30. The curable composition of claim 22, further comprising a second surfactant of Formula IIA, wherein at least one of the ratios x to y or z to y for the second surfactant is from 0.1:1 to 3:1.

31. (canceled)

32. (canceled)

33. A method of coating a substrate, comprising:
applying, to a substrate, a coating composition comprising:
a polysiloxane resin formed from siloxane monomer units and having the following formula: RₙSiO((4-n)/2), wherein R is alkyl or aryl;
wherein the polysiloxane resin comprises less than 80 mol % of T siloxane monomer units, based on the total moles of siloxane monomer units in the polysiloxane resin;
wherein the polysiloxane resin comprises less than 1 mol % of M and Q siloxane monomer units, based on the total moles of siloxane monomer units in the polysiloxane resin;
a solvent; and
a surfactant;
wherein the surfactant comprises at least one of:
a surfactant of Formula IIA 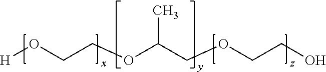
wherein x is an ethylene glycol monomer, y is a propylene glycol monomer and z is an ethylene glycol monomer;
a surfactant of Formula IIB 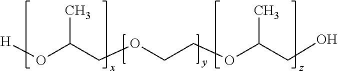
wherein x is a propylene glycol monomer, y is an ethylene glycol monomer, and z is propylene glycol monomer;
a surfactant of Formula III 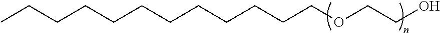
wherein n=16-20; and
a combination of surfactants of Formula IIA, IIB, and III; and
wherein a weight ratio of the surfactant to the polysiloxane resin is from 0.01 to 0.09, based on the total weight of the coating composition; and
curing the coating composition.

34. The method of claim 33, wherein the coating composition further comprises a condensation catalyst.

35. The method of claim 33, wherein before applying the coating composition to the substrate, the coating composition is diluted with water.

36. The method of claim 33, wherein the surfactant has an average molecular weight of 8000 g/mol to 15,000 g/mol and a hydrophilic-lipophilic balance (HLB) value greater than 10, as determined using Griffin's method or Davies Method.

37. The method of claim 33, wherein the polysiloxane resin further comprises:
a ratio of alkyl to Si of 1.1 to 1.4;
a ratio of methyl to phenyl groups of 0.4 to 1.

38. The method of claim 33, wherein the substrate is at least one of a metal, die cast aluminum, enamel frit, ceramic, plastic, or pre-coated substrate.

39. A polysiloxane resin formed from siloxane monomer units: 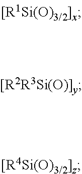
wherein:
x is any integer from 1 to 50;
y is any integer from 1 to 20;
z is any integer from 1 to 50;
R¹ is a C₁-C₃₀ linear or C₃-C₃₀ cyclic alkyl group;
R² and R³ are each independently a C₁-C₃₀ linear or C₃-C₃₀ cyclic alkyl group, or a C₆ or C₇ aryl group; and
R⁴ is a C₆ or C₇ aryl group;
wherein the polysiloxane resin comprises less than 80 mol % of T siloxane monomer units, based on the total moles of siloxane monomer units in the polysiloxane resin;
wherein the polysiloxane resin comprises less than 1 mol % of M and Q siloxane monomer units, based on the total moles of siloxane monomer units in the polysiloxane resin.

40. The polysiloxane resin of claim 39, wherein the polysiloxane resin comprises aryl groups, and comprises a mole ratio of aryl groups to silicon atoms of 0.8 or greater, based on total moles of aryl groups divided by total moles of silicon atoms based on mol % of monomers from which the polysiloxane resin is formed.

41. The polysiloxane resin of claim 39, wherein the polysiloxane resin comprises phenyl groups, and further wherein:
the polysiloxane resin comprises a mole ratio of phenyl groups to silicon atoms of 0.8 or greater, based on total moles of phenyl groups divided by total moles of silicon atoms based on mol % of monomers from which the polysiloxane resin is formed; and
the polysiloxane resin comprises:
a molar amount of monomer [R⁴Si(O)3/2]z greater than 60 mol % based on a total molar mass of the polysiloxane resin; and
a molar amount of monomer [R²R³Si(O)]y from 5 mol % to 30 mol % based on a total molar mass of the polysiloxane resin.

42. (canceled)

43. (canceled)

44. The polysiloxane resin of claim 39, wherein the polysiloxane resin comprises alkyl groups and aryl groups and comprises a mole ratio of alkyl groups to aryl groups of 0.45 or less, based on total moles of alkyl groups divided by total moles of aryl atoms based on mol % of monomers from which the polysiloxane resin is formed.

45. The polysiloxane resin of claim 39, wherein the polysiloxane resin comprises methyl groups and phenyl groups and comprises a mole ratio of methyl groups to phenyl groups of 0.45 or less, based on total moles of methyl groups divided by total moles of phenyl atoms based on mol % of monomers from which the polysiloxane resin is formed.

46. The polysiloxane resin of claim 39, wherein the polysiloxane resin comprises monomer residues of each of the following siloxane monomers:
phenyltrialkoxy silane;
phenylmethyldialkoxy silane;
methyltrialkoxy silane; and
diphenyldialkoxy silane.

47. The polysiloxane resin of claim 39, wherein the polysiloxane resin further comprises a solvent in an amount from 5-35 wt. %, based on the total weight of the polysiloxane resin.
